(19) United States
(12) Patent Application Publication
(10) Pub. No.: US 2009/0165436 A1
(43) Pub. Date: Jul. 2, 2009

(54) Premixed, preswirled plasma-assisted pilot

(75) Inventors: John Thomas Herbon, Rexford, NY (US); Grover Andrew Bennett, Schenectady, NY (US); Anthony John Dean, Scotia, NY (US); Michael Solomon Idelchik, Niskayuna, NY (US); Seyed Gholamali Saddoughi, Clifton Park, NY (US); Abdelkrim Younsi, Ballston Lake, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 12/005,807

(22) Filed: Dec. 28, 2007

(51) Int. Cl. F02C 7/266; F02C 7/22

(52) U.S. Cl. 60/39.826; 60/772; 60/737

(57) ABSTRACT

A plasma enhanced pilot including a swirler mechanism is configured to be inserted into an existing blank (purge air) or liquid fuel (dual fuel) cartridge space within the centerbody of a lean, premixed land-based gas turbine combustor fuel nozzle.

### BACKGROUND

The invention relates generally to gas turbine combustors, and more specifically to an electrical discharge device used to improve lean blow-out limits and reduce combustion instabilities of a gas turbine combustor.

Fully premixed lean-combustion is a key enabler of low nitric-oxide (NOx) emissions at high firing rates. This is also referred to as dry-low-NOx (DLN) combustion, as it achieves low NOx emissions without the addition of steam or water to keep peak combustion temperatures down. One of the issues that arises in lean premixed combustion is the occurrence of thermo-acoustic instabilities or combustion dynamics, which if left unchecked, can cause large enough pressure fluctuations to damage gas turbine hardware. Plasma-assisted combustion is one technology that has been identified as a potential technology to affect or control the combustion process (the effective reaction rates and/or flame stabilization) so as to be able to counteract the acoustic/thermal feedback loop which drives combustion dynamics.

Another challenge associated with gas turbines is turn-down. During the daily off-peak hours of operation, gas turbine operators (power generation companies) turn down the power output of their machines due to the lower electricity demand. A complete shut-down of the machine on a daily basis is undesirable as it causes early cycle fatigue of the gas turbine components. Further, there is a cost associated with the shut-down and start-up processes. These costs are traded for the operating costs of running the gas turbine during times of low demand (and therefore low-value electricity generation).

Generally, DLN systems are unable to turn down below ˜40-50% of base load while in fully premixed mode. Methods to turn down below this level (e.g. decreasing the fuel-to-air ratio, staging the fuel to only a portion of the nozzles, or turning on a diffusion pilot flame) incur undesirable side effects (e.g. flame instabilities at lean flammability limits, high carbon monoxide (CO) emissions due to incomplete combustion, and high NOx due to high diffusion flame temperatures).

Yet another challenge associated with gas turbines is combustion ignition, both in land-based gas turbines and for aircraft engines at high altitudes.

Challenges associated with applying plasma-assisted combustion technology in gas turbines include without limitation difficulties associated with generating electrical discharges at elevated gas densities and isolating high voltage electrodes inside a combustion chamber.

Known techniques for addressing some of the foregoing challenges have included 1) gas turbine turndown achieved by fuel staging among several nozzles within a combustor can, undesirably producing high CO emissions, 2) staged combustion, and 3) transition to partially premixed or non-premixed combustion, also undesirably producing high NOx emissions.

In view of the foregoing, it would be both advantageous and beneficial to provide a system and method of improving lean blow-out limits of a gas turbine combustor. It would be further advantageous if the system and method could be easily configured for use as an ignition source and as a means to reduce combustion instabilities.

### BRIEF DESCRIPTION

Briefly, in accordance with one embodiment, a plasma enhanced pilot comprises a swirler mechanism disposed substantially within the pilot and configured to receive pilot fuel and pilot air and swirl the pilot fuel and pilot air substantially within the swirler to provide a premixed, pre-swirled fuel/air mixture, the pilot being disposed substantially within the centerbody of a premixed fuel/air nozzle portion of a gas turbine combustor.

In some embodiments, the swirler mechanism is disposed solely within the pilot. In other embodiments, the swirler mechanism is configured to receive pilot fuel and pilot air and swirl the pilot fuel and pilot air solely within the swirler mechanism. In yet other embodiments, the pilot is disposed solely within the centerbody of a premixed fuel/air nozzle portion of a gas turbine combustor.

According to another embodiment, a plasma enhanced pilot comprises a swirler mechanism, the pilot configured to be inserted into an existing blank (purge air) or liquid fuel (dual fuel) cartridge space within the centerbody of a lean, premixed land-based gas turbine combustor fuel nozzle.

According to yet another embodiment, a method of generating a gas turbine combustor pilot flame comprises:

providing a swirler mechanism disposed substantially within a pilot disposed solely within the centerbody of a premixed fuel/air nozzle portion of a gas turbine combustor;

premixing and pre-swirling a fuel/air mixture substantially within the swirler mechanism; and

igniting the premixed, pre-swirled fuel/air mixture exiting the pilot to form plasma enhanced pilot flame gases substantially within a pilot flame region within a main combustion zone within the gas turbine combustor.

According to still another embodiment, a plasma enhanced pilot is disposed within an existing blank (purge air) or liquid fuel (dual fuel) cartridge space within the centerbody of a lean, premixed land-based gas turbine combustor fuel nozzle, the plasma enhanced pilot comprising a high voltage electrode disposed at least partially within a dielectric barrier, wherein the dielectric barrier is configured to prevent high current flow during electrical discharge of the high voltage electrode to provide a cold or non-equilibrium plasma having NOx emissions below that generated by hot or thermalized (equilibrium) plasmas.

According to still another embodiment, a plasma enhanced pilot is disposed solely within an existing blank (purge air) or liquid fuel (dual fuel) cartridge space within the centerbody of a lean, premixed land-based gas turbine combustor fuel nozzle, the pilot being configured to generate a cold or non-equilibrium plasma within the pilot having NOx emissions below that generated by hot or thermalized (equilibrium) plasmas.

### DRAWINGS

These and other features, aspects, and advantages of the present invention will become better understood when the following detailed description is read with reference to the accompanying drawings in which like characters represent like parts throughout the drawings, wherein:

FIG. 1 is a side cross-sectional view illustrating a premixed, pre-swirled, plasma-assisted pilot according to one aspect of the invention;

FIG. 2 is a top cross-sectional view of the pilot depicted in FIG. 1;

FIG. 3 is a side cross-section view of a DLN gas turbine nozzle including a premixed, pre-swirled, plasma-assisted pilot according to one aspect of the invention;

FIG. 4 is a DLN gas turbine nozzle that does not have a plasma pilot for use to provide plasma-assisted combustion and that is known in the art;

FIG. 5 is a DLN gas turbine nozzle useful in providing plasma-assisted combustion according to another aspect of the invention;

FIG. 6 is a detailed view of the plasma-assisted premixed pilot nozzle depicted in FIG. 5 illustrating a plasma discharge, according to one aspect of the invention;

FIG. 7 illustrates in more detail, the plasma-assisted pilot portion of the DLN nozzle shown in FIGS. 5 and 6;

FIG. 8 is a top view of the plasma-assisted pilot depicted in FIG. 7;

FIG. 9 is a bottom view of the plasma-assisted pilot depicted in FIG. 7; and

FIG. 10 is a cutaway view of the plasma-assisted pilot depicted in FIG. 7.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

The embodiments described herein below with reference to the Figures are directed to a pilot that includes a mechanism to swirl air and fuel or a fuel/air mixture to provide a premixed, pre-swirled plasma-assisted (enhanced) pilot flame suitable for use with a gas turbine combustor. According to one embodiment, the pilot is located in the centerbody of a premixed fuel/air nozzle of a gas turbine combustor and operates to improve lean blow-out limits (LBO) of the combustor. The pilot can also function, without limitation, as an ignition source and/or as a means to reduce combustion instabilities.

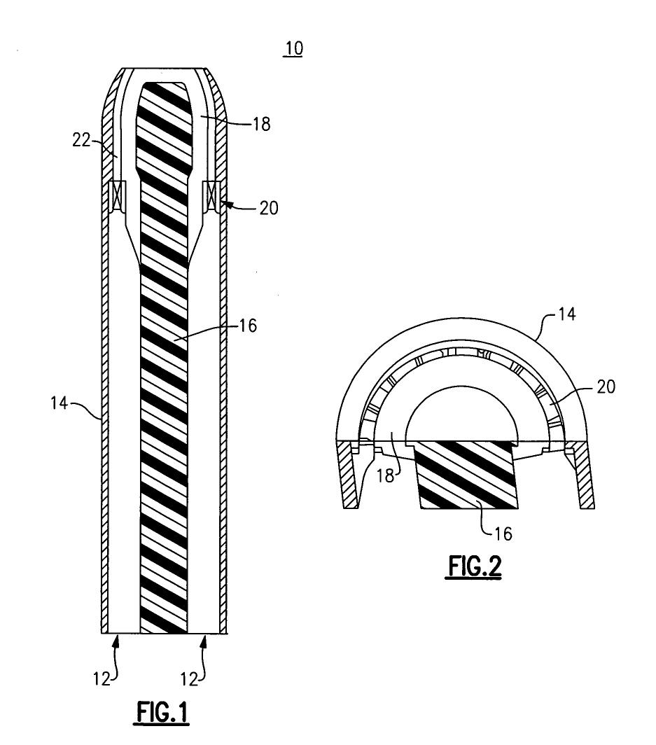

Looking now at FIG. 1, a side cross-sectional view illustrates a premixed, pre-swirled, plasma-assisted pilot 10 according to one aspect of the invention. The pilot 10 includes a swirler mechanism 20 to swirl air and fuel or a fuel/air mixture that enters pilot 10 via one or more inlet ports 12. The resulting premixed and pre-swirled fuel/air mixture exits the swirler mechanism 20 via a passage formed by respective inner high voltage and outer low voltage electrodes 16, 14. The electrodes 14, 16 may be bare conductive materials, or one or both electrodes may be encapsulated by a dielectric material 18. A high voltage electric field is generated between the electrodes, igniting an electrical discharge in the fuel/air mixture. This electrical discharge creates ions, energetic species, and dissociation products from the air and fuel. Along with the chemical aspects of the foregoing electrical discharge, some thermal heating of the gas also occurs. Finally, short-lived highly reactive radical species are created. The combination of radical species and increased temperature ignites the pilot fuel/air mixture exiting pilot 10. The premixed fuel/air mixture in the pilot 10 discharge region flows at a velocity high enough to prevent the ignited pilot flame from traveling upstream into the pilot cartridge. Velocities in this area can be, without limitation, between about 150 and about 250 feet/second. These high velocities also act to 1) assist distribution of the discharge streamers, discussed in further detail below, 2) prevent hot arcs from forming, and 3) keep the electrode surfaces cool both due to the high velocity flow and by pushing the flame downstream away from the nozzle surfaces.

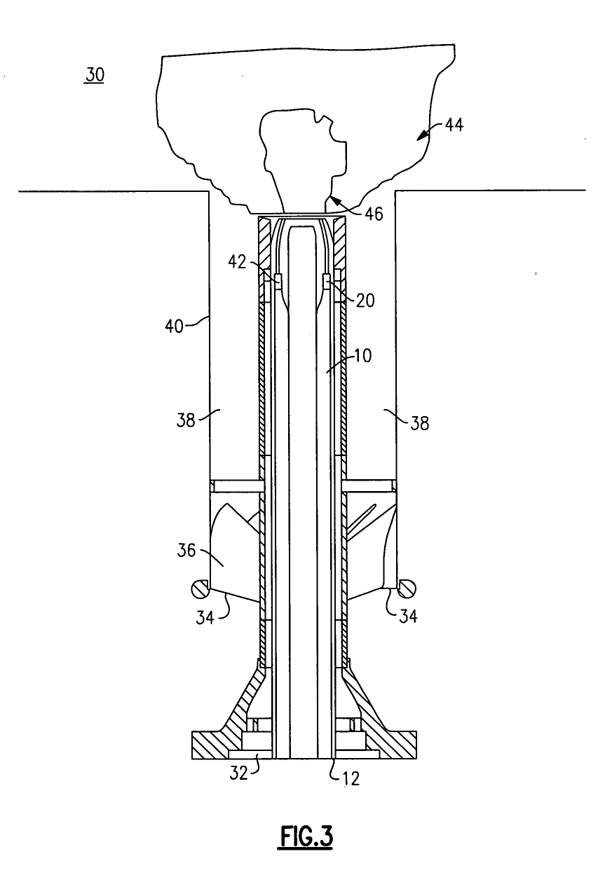

The swirling, reacting, radical-enhanced fuel/air mixture exits the pilot 10 and enters into the main combustion zone (described herein below with reference to FIGS. 3, 5 and 6). In the main combustion zone, the pilot flame gases interact and mix with the much larger lean premixed fuel/air flow exiting the main part of the fuel nozzle. The hot, radical-enhanced pilot gases act as an ignition source and stabilization mechanism for the main lean fuel/air mixture.

In lean turn-down conditions, the pilot 10 can act to improve the lean blow-out limits of the combustor by stabilizing a lean main fuel/air mixture that is otherwise unstable or beyond the lean blow-out limits. Further, in situations where thermo-acoustic instabilities are driving combustion dynamics, the pilot 10 can again act as a stabilizing mechanism for the main flame; or it can be modulated to counteract the specific dynamic combustion tones.

FIG. 2 is a top cross-sectional view of the pilot 10 depicted in FIG. 1, and can be seen to include an inner high voltage electrode 16 disposed in the center portion of the pilot 10. A dielectric insulator 18 surrounds the high voltage electrode 16. An annular swirler mechanism 20 surrounds the dielectric insulator 18. The outer shell 14 of the pilot 10 forms an outer electrode that is connected to a suitable machine ground. The swirler mechanism 20 operates to provide a premixed, pre-swirled fuel/air mixture upstream of a discharge (plasma) region 22. The dielectric insulator 18 can be eliminated in one embodiment. In either case, the bare or dielectric-covered electrodes can be energized using either pulsed or AC power to achieve the desired results. The AC power can be implemented using a sine wave or other continuous periodic waveform; while the pulsed power can be implemented using pulses having a very short rise time (˜5-20 ns) and a short pulse length (˜20 ns-100 μs).

The pilot embodiments described herein can operate to provide plasma-assisted, premixed piloted combustion to enhance the combustion process at low turn-down conditions while avoiding the undesirable effects discussed above. Chemical activation of a portion of the fuel, air, or fuel/air mixture may enhance the overall reaction processes of the combustor, by generating reactive species and high temperatures that stabilize the main premixed fuel-air flow. Thus, the lean flammability limits of the whole combustor are extended to lower fuel-to-air ratios. The present inventors recognized that turbulent mixing of the reacting pilot gases with the main premixed fuel/air flow should enhance the reactivity of the whole combustor, enabling faster burnout rates of the CO, and that a lean or rich premixed pilot avoids the peak flame temperatures, and therefore the NOx generation which occurs in a diffusion flame pilot.

Particular pilot embodiments described herein can also act, for example, as an integral igniter in each fuel nozzle for a can combustor system to eliminate cross-fire tubes, if so desired. Further, particular embodiments described herein may also enlarge the overall ignition envelope for both can and annular combustors. Particular embodiments of the pilot described herein also allow integration and use of plasma technology in a gas turbine fuel nozzle, thus overcoming challenges associated with incorporating isolated high voltage electrodes into a combustion chamber.

Moving now to FIG. 3, a side cross-section view of a DLN gas turbine nozzle 30 including a premixed, pre-swirled, plasma-assisted pilot 10 is illustrated according to one aspect of the invention. The main supply air into the DLN nozzle 30 enters through an air inlet port 34 and passes through its own air swirler 36 where it continues to flow into the main combustion zone 44. Prior to entering the main combustion zone 44, the swirled main air mixes with a main supply fuel within a burner tube 40 passageway 38. The main supply fuel enters through one or more main fuel ports 32 to provide the main fuel supply. The main air is then mixed with the main fuel to provide the main premixed fuel that flows through the DLN gas turbine nozzle burner tube 40 and into the combustion zone 44.

Pilot air enters through a pilot air entry port 12 and therefrom flows into the pilot swirler mechanism 20. Pilot fuel enters through one or more pilot fuel entry ports 32 and therefrom also flows into the pilot swirler mechanism 20 via a swirler fuel entry port 42 that is positioned substantially downstream from the pilot fuel entry port 32. Although separate flowpaths are not depicted for the main and pilot fuel, these two fuel circuits can optionally be separate and independently controlled. The fuel and air are together swirled within swirler mechanism 20 to provide a premixed, pre-swirled fuel/air combination that exits the pilot 10 and is passed into the combustion zone 44 where it is ignited along with the main premixed fuel to generate a premixed, plasma-enhanced pilot flame 46 within the main premixed flame.

According to one embodiment, the main premixed fuel is mixed solely with its own main supply air, while the premixed, pre-swirled pilot fuel is mixed solely with its own pilot supply air to more accurately control and achieve a desired premixed, plasma-enhanced pilot flame within the combustion zone 44. The premixed fuel/air mixture in the pilot can be comprised such that it is a fuel-lean mixture (one which includes excess air), a fuel-rich mixture (one which has insufficient air for combustion), or a stoichiometric mixture (a mixture having the exact required ratio of fuel and air for complete combustion). Further, the ratio of the flow rate of premixed, pre-swirled, plasma-enhanced pilot fuel/air mixture and the flow rate of additional non-premixed purge air in the centerbody of the fuel nozzle can be adjusted in various ways to optimize the performance of the plasma-enhanced pilot flame in igniting and stabilizing the combustion of the main premixed fuel/air mixture in the combustor. Alternative embodiments can be configured such that 1) the pilot air and fuel are fully premixed upstream of the fuel nozzle, 2) the pilot fuel enters the pilot air upstream of the swirler, 3) the pilot fuel enters the pilot air as part of the swirler, 4) the pilot fuel enters the pilot air downstream of the swirler.)

Advantages provided by the DLN gas turbine nozzle 30 comprising a premixed, pre-swirled, plasma-assisted pilot 10 include without limitation:

provision of a premixed fuel and air in the pilot flame that avoids the NOx created by high temperatures found in diffusion pilot flames;

a small annular discharge gap distance (electrical discharge passage height ˜1.5-3 mm, enumerated 22 in FIG. 1) that permits the creation of discharges using reasonable voltages (<100 kV) at high pressures (5-20 atm) and temperatures between about 500° F. to about 900° F.;

provision of an annular discharge passage that naturally fits into a swirl-stabilized fuel/air nozzle;

provision of an annular discharge passage that contributes to a uniform electric field in which the discharge occurs, thus providing an increased likelihood that a uniformly distributed discharge is created;

provision of a swirled pilot flow that provides inherent aerodynamic stabilization such that in certain circumstances the pilot may function without turning on the plasma;

provision of a turbulent swirling flow that will enhance mixing of the pilot flame gases with the main swirling premixed flow;

provision of a turbulent swirling flow within the pilot discharge volume that contributes to a better distribution of the discharge streamers and/or diffuse glow volume;

provision of a structure that permits the inner high voltage electrode to be electrically insulated from the machine by use of high voltage insulating feedthroughs in which the outer electrode is grounded to the fuel nozzle in which it is inserted;

provision of a dielectric barrier capability according to one aspect that includes encapsulation of the inner electrode by a dielectric material (e.g., high temperature ceramic) to provide a colder plasma by preventing high current flow during the discharge process, a feature that is advantageous since hot or thermalized plasmas have been shown to create their own NOx;

provision of a structure having the ability to operate with both pulsed high voltage power as well as more conventional AC high voltage power in which the electrical power can be applied at 10-50 kHz frequencies or modulated at frequencies of interest in the combustor (10's to 1000's of Hz) to counteract combustion dynamic tones;

provision of a plasma discharge that is located just upstream of and inside the pilot flame front region, placing the discharge right at the entrance into the flame zone, a feature that is more critical at high pressures, where active species will more quickly be collisionally quenched; and

provision of a pilot that is inserted into existing space within the centerbody of a land-based gas turbine combustor fuel nozzle (e.g., DLN system) in which the pilot can take the place of a blank (purge air) or liquid fuel (dual fuel) cartridge that currently is installed in the centerbody. Thus, the main premixed fuel/air combustion is enhanced without making any modifications to the critical premixed burner tube area where flashback and flameholding are challenges to be avoided.

FIG. 4 is a DLN gas turbine nozzle 60 that does not have a plasma pilot for use to provide plasma-assisted combustion, and that is known in the art. DLN gas turbine nozzle 60 can be seen to include an air cartridge 62 disposed within the centerbody of the nozzle 60 that receives cooling/purge air. Diffusion fuel enters the nozzle 60 via an annular diffusion fuel port 64 between the air cartridge 62 and the centerbody of the nozzle 60. A main premixed fuel is supplied to the nozzle 60 via one or more outer main premix fuel ports 66. A main air supply enters the nozzle 60 via an outermost annular main entry air port 68.

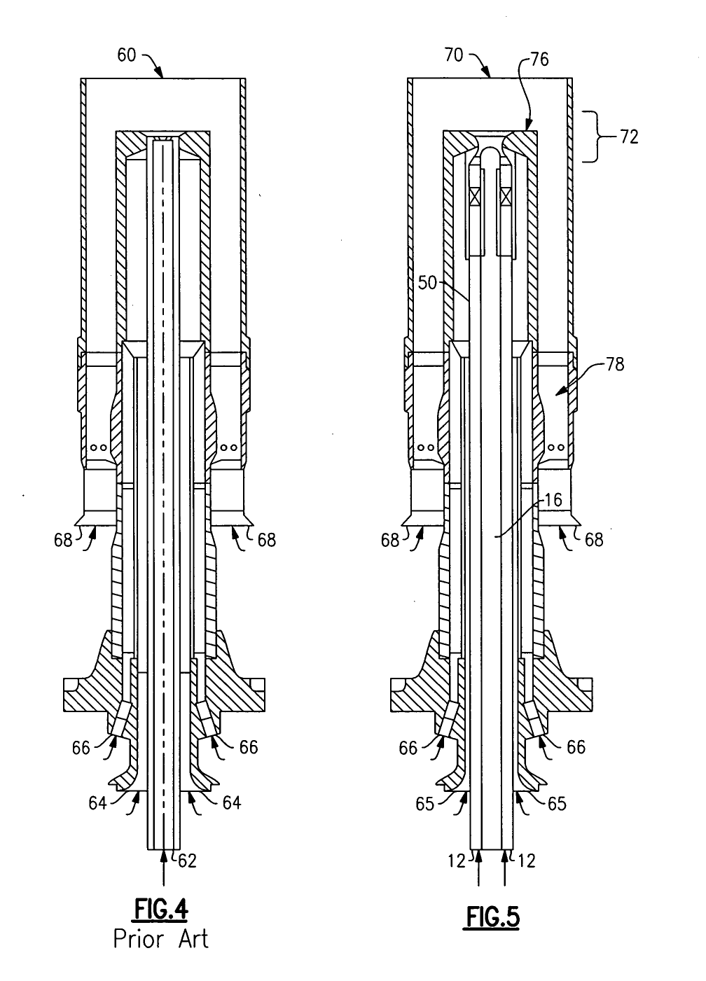

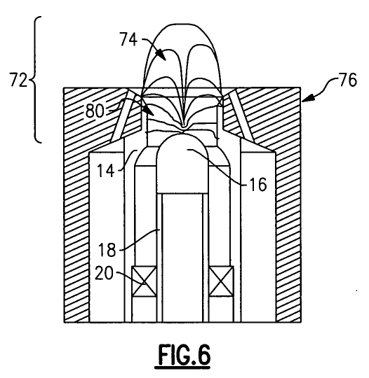

Moving now to FIG. 5, a DLN gas turbine nozzle 70 useful for providing plasma-assisted combustion is illustrated according to another aspect of the invention. Nozzle 70 includes a pilot 50, described in further detail with reference to FIGS. 6-10 below, disposed within the centerbody of the nozzle 70. Air and fuel, or a premixed fuel/air mixture enter the pilot 50 via one or more ports 12; and so there is no longer any need for a diffusion fuel port 64 such as that shown in the nozzle 60 depicted in FIG. 4. A cooling/purge air enters the nozzle 70 via an entry port 65 disposed between the pilot and the centerbody of the nozzle 70. A main premixed fuel is supplied to the nozzle 70 via an outer annular main premix fuel port 66. A main air supply enters the nozzle 70 via an outermost annular main entry air port 68.

The pilot 50 disposed within the centerbody of the DLN gas turbine nozzle 70 can be seen to include a high voltage electrode 16 such as discussed herein before. A more detailed depiction of the plasma-assisted, premixed pilot 50 is shown in FIG. 6 that also illustrates a plasma discharge 74 according to one aspect of the invention. The plasma discharge 74 lies within a plasma region 72 that is formed within the DLN gas turbine nozzle 70 combustion zone upon electrical discharging of the high voltage electrode 16 in a manner such as described above.

Pilot 50 further includes in addition to the high voltage electrode 16, a pilot outer body/outer electrode 14 that is grounded to the gas turbine, a dielectric insulator 18 such as discussed above, and a swirler mechanism 20 disposed downstream of the air and fuel or premixed fuel/air entry port 12 and upstream from the plasma region 72. The present embodiments are not so limited, and it will be appreciated that fuel can be injected anywhere in the pilot cartridge, such that it premixes upstream of the plasma region.

FIG. 6 also illustrates plasma characteristics associated with the premixed, pre-swirled, plasma-assisted pilot 50 depicted in FIGS. 5-6, according to one aspect of the invention. High voltage waveforms applied between the inner high voltage electrode 16 and the outer low voltage electrode 14 cause plasma streamers 80 to be generated throughout a channel region and on into the flame region 74, where the streamers 80 eventually dissipate as new streamers 80 are initiated at the discharge tip of the high voltage electrode 16.

FIGS. 7-10 illustrate in more detail, the plasma-assisted pilot portion of the DLN nozzle 70 shown in FIGS. 5 and 6. As described above, a premixed fuel/air mixture is introduced into the pilot entry port 12 where it flows through an annular passageway into an annular swirler 20. Alternatively, air is introduced into the pilot entry port 12, while the pilot fuel is introduced upstream of the swirler 20, downstream of the swirler 20, or directly into the swirler 20 via an entry port in proximity to the swirler 20, as described above according to one aspect with reference to FIG. 3. The fuel and air or fuel/air mixture are together swirled within the swirler 20 to provide a premixed, pre-swirled pilot fuel/air mixture that exits the swirler 20 on its way to the discharge region 72. The swirler 20 in one aspect includes a plurality of arcuate type vanes that cause the fuel and air mixture to more thoroughly mix and swirl as the mixture passes through the swirler 20.

A dielectric barrier 18, depicted also in FIGS. 1-2, isolates the high voltage electrode 16 from the low voltage electrode 14 and the ground portion of the nozzle 70. According to one embodiment, the inner high voltage electrode 16 is electrically insulated from the machine by use of high voltage insulating feedthroughs in which the outer electrode 14 is grounded to the fuel nozzle 70 in which it is inserted. Provision of a dielectric barrier capability according to one aspect that includes at least partial encapsulation of the inner and/or outer electrode 16 by a dielectric material (e.g., high temperature ceramic) 18 that helps to provide a colder plasma by preventing high current flow during the discharge process, a feature that is advantageous since hot or thermalized plasmas have been shown to create their own NOx.

A workable dielectric barrier, enumerated 18 in FIGS. 1-2 and 6-10, according to one embodiment may comprise without limitation, a high temperature, high dielectric breakdown strength aluminum oxide coating uniformly applied to the outer surface of the inner high voltage electrode 16 or a high dielectric breakdown strength solid-formed ceramic material in which the inner high voltage electrode 16 is located. The dielectric barrier 18 provides a plurality of advantages including without limitation, 1) limiting the power consumption required to generate the plasma since the dielectric barrier assists in preventing an arc which would cause a very high current draw plasma, 2) more volumetric discharges such that the combustion region is more completely filled with plasma, and 3) preservation of electrode life due to a lower temperature plasma discharge and reduced localized heating of the plasma.

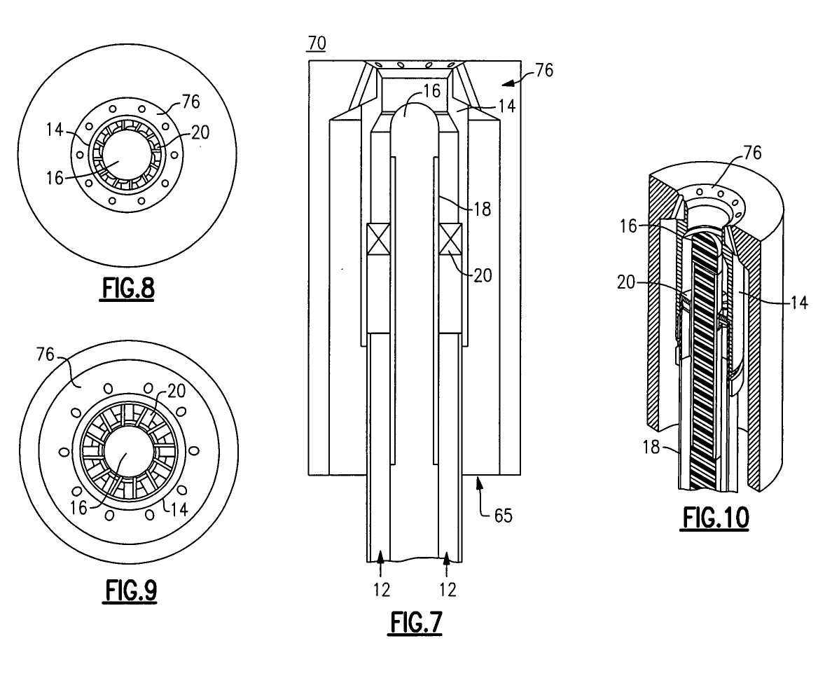

FIG. 8 is a top view of the plasma-assisted pilot DLN nozzle 70 depicted in FIG. 7, while FIG. 9 is a bottom view of the plasma-assisted pilot DLN nozzle 70 depicted in FIG. 7. These views illustrate the annular structure of the pilot 50 that is suitable for integration into the centerbody portion of the DLN nozzle 70 to resolve combustion challenges including without limitation, providing a swirled, premixed, plasma-enhanced pilot flame to solve issues such as discussed above directed to lean turn down, dynamics, and ignition in a lean premixed gas turbine nozzle.

FIG. 10 is a cutaway view of the plasma-assisted pilot DLN nozzle 70 depicted in FIG. 7.

In summary explanation, particular embodiments have been described for a plasma-assisted premixed pilot that improves lean turn-down capabilities of a gas turbine combustor, and that can be implemented as a retrofit for existing fuel nozzles and machines. The pilot generates a swirled, premixed, plasma-enhanced pilot flame that is applied to solve combustion challenges including without limitation, lean turn down, dynamics, and ignition. Particular embodiments are directed to a specific geometry that is integrated inside the centerbody of a DLN nozzle to generate a premixed plasma-enhanced pilot flame.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A plasma enhanced pilot comprising a swirler mechanism disposed substantially within the pilot and configured to receive pilot fuel and pilot air and swirl the pilot fuel and pilot air within the swirler to provide a premixed, pre-swirled fuel/air mixture, the pilot being disposed substantially within the centerbody of a premixed fuel/air nozzle portion of a gas turbine combustor.

2. The plasma enhanced pilot according to claim 1, further comprising a high voltage electrode disposed at least partially within a dielectric barrier, wherein the dielectric barrier is configured to prevent high current flow during electrical discharge of the high voltage electrode to provide a cold or non-equilibrium plasma having NOx emissions below that generated by hot or thermalized (equilibrium) plasmas.

3. The plasma enhanced pilot according to claim 1, wherein the swirler mechanism is further configured with a fuel entry port and an air entry port.

4. The plasma enhanced pilot according to claim 1, further comprising a fuel entry port disposed upstream of the swirler mechanism.

5. The plasma enhanced pilot according to claim 1, further comprising a fuel entry port disposed downstream of the swirler mechanism.

6. The plasma enhanced pilot according to claim 1, wherein the swirler mechanism is configured with a single mixed fuel/air entry port.

7. The plasma enhanced pilot according to claim 1, further comprising:
a high voltage electrode; and
a low voltage electrode, wherein the high voltage electrode and the low voltage electrode together have a discharge gap distance between the electrodes of about 1.5 mm to about 3 mm.

8. The plasma enhanced pilot according to claim 1, further comprising:
a high voltage electrode; and
a low voltage electrode, wherein the high voltage electrode and the low voltage electrode together are configured to permit creation of electrical discharges using voltage levels less than about 100 kV at high pressures between about 5 atm and about 20 atm and temperatures between about 500° F. to about 900° F.

9. The plasma enhanced pilot according to claim 1, wherein the pilot further comprises an annular discharge passage configured to fit naturally within a swirl-stabilized fuel/air nozzle to support creation of a uniform electric discharge field.

10. The plasma enhanced pilot according to claim 1, wherein the swirler mechanism is further configured to provide a premixed, pre-swirled fuel/air mixture having an inherent aerodynamic stabilization that is sufficient without generation of pilot plasma to improve lean turn-down capabilities of the gas turbine combustor to a desired level.

11. The plasma enhanced pilot according to claim 1, wherein the swirler mechanism is further configured to provide a premixed, pre-swirled fuel/air mixture to enhance mixing of pilot flame gases with a main swirling premixed fuel/air flow generated by the gas turbine fuel nozzle.

12. The plasma enhanced pilot according to claim 11, wherein the swirler mechanism is configured to rotate in the same direction as a main swirler providing the main swirled premixed fuel/air flow.

13. The plasma enhanced pilot according to claim 11, wherein the swirler mechanism is configured to rotate in a counter-rotating direction to a main swirler providing the main swirled premixed fuel/air flow.

14. The plasma enhanced pilot according to claim 1, wherein the swirler mechanism is further configured to provide a swirling motion of fuel/air inside the pilot electrical discharge volume that contributes to a desired distribution of discharge streamers.

15. The plasma enhanced pilot according to claim 1, wherein the swirler mechanism is further configured to provide a swirling motion of fuel/air inside the pilot electrical discharge volume that contributes to a desired distribution of diffuse glow volume.

16. The plasma enhanced pilot according to claim 1, wherein the pilot further comprises a high voltage electrode electrically insulated from the gas turbine combustor via high voltage insulating feedthrough elements.

17. The plasma enhanced pilot according to claim 1, further comprising a high voltage electrode and a low voltage electrode, the pilot configured to generate a plasma discharge therefrom, wherein the high voltage electrode and the low voltage electrode together are configured to initiate a discharge in the premixed, pre-swirled fuel/air mixture in response to pulsed high voltage power or AC high voltage power, and further wherein the plasma discharge is located substantially at the entrance into the gas turbine combustor flame region.

18. The plasma enhanced pilot according to claim 17, wherein the pulsed or AC high voltage power is applied at about 10 kHz to about 50 kHz.

19. The plasma enhanced pilot according to claim 17, wherein the pulsed or AC high voltage power is modulated between about 10 Hz and about 2.5 kHz such that undesired gas turbine combustion tones are substantially eliminated.

20. A plasma enhanced pilot comprising a swirler mechanism, the pilot configured to be inserted into an existing blank (purge air) or liquid fuel (dual fuel) cartridge space within the centerbody of a lean, premixed land-based gas turbine combustor fuel nozzle.

21. The plasma enhanced pilot according to claim 20, wherein the pilot is further configured to be inserted into the existing blank (purge air) or liquid fuel (dual fuel) cartridge space in the absence of modifications to a premixed burner tube area of the land-based gas turbine combustor fuel nozzle.

22. The plasma enhanced pilot according to claim 20, wherein the pilot comprises a high voltage electrode and/or low voltage electrode disposed at least partially within a dielectric barrier, wherein the dielectric barrier is configured to prevent high current flow during electrical discharge of the high voltage electrode to provide a cold or non-equilibrium plasma having NOx emissions below that generated by hot or thermalized (equilibrium) plasmas.

23. The plasma enhanced pilot according to claim 20, wherein the swirler mechanism is configured to premix and pre-swirl a pilot fuel and a pilot air together within the swirler mechanism.

24. A method of generating a gas turbine combustor pilot flame, the method comprising:
providing a swirler mechanism disposed substantially within a pilot disposed substantially within the centerbody of a premixed fuel/air nozzle portion of a gas turbine combustor;
premixing and pre-swirling a fuel/air mixture substantially within the swirler mechanism; and
creating a plasma discharge in the premixed, pre-swirled fuel/air mixture exiting the pilot to form plasma enhanced pilot flame gases substantially within a pilot flame region within a main combustion zone within the gas turbine combustor.

25. The method according to claim 24, wherein providing a swirler mechanism disposed solely within a pilot disposed solely within the centerbody of a premixed fuel/air nozzle portion of a gas turbine comprises providing a pilot disposed solely within an existing blank (purge air) or liquid fuel (dual fuel) cartridge space in the absence of modifications to the premixed burner tube area of a land-based gas turbine combustor fuel nozzle.

26. The method according to claim 24, further comprising passing air directly into the swirler mechanism via a pilot supply air passage and passing fuel directly into the swirler mechanism via a pilot supply fuel passage such that together the supplied air and fuel combine to form the fuel/air mixture.

27. The method according to claim 24, wherein creating a plasma discharge in the premixed, pre-swirled fuel/air mixture exiting the pilot to form plasma enhanced pilot flame gases substantially within a pilot flame region within a main combustion zone within the gas turbine combustor comprises applying a pulsed high voltage power or an AC high voltage power to a high voltage electrode and a low voltage electrode configured together to initiate a discharge in the premixed, pre-swirled pilot fuel/air mixture therefrom in response to the pulsed high voltage power or AC high voltage power such that the plasma discharge is located substantially at the entrance into the gas turbine combustor pilot flame region or substantially between the high voltage electrode and the low voltage electrode.

28. The method according to claim 27, wherein applying a pulsed or AC high voltage power to a high voltage electrode and a low voltage electrode comprises applying a pulsed or AC high voltage power at about 10 kHz to about 50 kHz.

29. The method according to claim 27, wherein applying a pulsed or AC high voltage power to a high voltage electrode and a low voltage electrode comprises modulating the pulsed or AC high voltage power between about 10 Hz and about 2.5 kHz such that undesired gas turbine combustion tones are substantially eliminated.

30. The method according to claim 24, wherein creating a plasma discharge in the premixed, pre-swirled fuel/air mixture exiting the pilot to form plasma enhanced pilot flame gases substantially within a pilot flame region within a main combustion zone within the gas turbine combustor comprises applying microwave power or radio frequency power to initiate a discharge in the premixed, pre-swirled pilot fuel/air mixture such that the plasma discharge is located substantially at the entrance into the gas turbine combustor pilot flame region or substantially between the high voltage electrode and the low voltage electrode.

31. A plasma enhanced pilot disposed within an existing blank (purge air) or liquid fuel (dual fuel) cartridge space within the centerbody of a lean, premixed land-based gas turbine combustor fuel nozzle, the plasma enhanced pilot comprising a high voltage electrode disposed at least partially within a dielectric barrier, wherein the dielectric barrier is configured to prevent high current flow during electrical discharge of the high voltage electrode to provide a cold or non-equilibrium plasma having NOx emissions below that generated by hot or thermalized (equilibrium) plasmas.

32. The plasma enhanced pilot according to claim 31, further comprising a low voltage electrode, wherein the high voltage electrode and the low voltage electrode together are configured to permit creation of electrical discharges using voltage levels less than about 100 kV at high pressures between about 5 atm and about 20 atm and temperatures between about 500° F. to about 900° F.

33. The plasma enhanced pilot according to claim 31, wherein the pilot further comprises an annular discharge passage configured to fit naturally within a swirl-stabilized fuel/air nozzle to support creation of a uniform electric discharge field.

34. The plasma enhanced pilot according to claim 31, wherein the high voltage electrode is electrically insulated from the gas turbine combustor via high voltage insulating feedthrough elements.

35. The plasma enhanced pilot according to claim 31, further comprising a low voltage electrode, wherein the high voltage electrode and the low voltage electrode are configured together to initiate a discharge in a premixed, pre-swirled fuel/air mixture in response to pulsed high voltage power or AC high voltage power such that the plasma discharge is located substantially at the entrance into a gas turbine combustor flame region.

36. The plasma enhanced pilot according to claim 35, wherein the pulsed or AC high voltage power is applied in a range between about 10 kHz to about 50 kHz.

37. The plasma enhanced pilot according to claim 35, wherein the pulsed or AC high voltage power is modulated between about 10 Hz and about 2.5 kHz such that undesired gas turbine combustion tones are substantially eliminated.

38. The plasma enhanced pilot according to claim 33, wherein the discharge passage is configured to generate a plasma discharge therefrom in response to microwave power or radio frequency power and ignite a premixed, pre-swirled fuel/air mixture such that the plasma discharge is located substantially at the entrance into a gas turbine combustor flame region.

39. A plasma enhanced pilot disposed substantially within an existing blank (purge air) or liquid fuel (dual fuel) cartridge space within the centerbody of a lean, premixed land-based gas turbine combustor fuel nozzle, the pilot configured to generate a cold or non-equilibrium plasma within the pilot having NOx emissions below that generated by hot or thermalized (equilibrium) plasmas.

40. The plasma enhanced pilot according to claim 39, further comprising a high voltage and/or low voltage electrode disposed at least partially within a dielectric barrier, wherein the dielectric barrier is configured to prevent high current flow during electrical discharge of the high voltage electrode to provide the cold plasma having NOx emissions below that generated by hot or thermalized plasmas.

41. The plasma enhanced pilot according to claim 39, further comprising a swirler mechanism disposed solely within the pilot and configured with a fuel entry port and an air entry port.

42. The plasma enhanced pilot according to claim 39, further comprising a swirler mechanism disposed solely within the pilot and a fuel entry port disposed upstream of the swirler mechanism.

43. The plasma enhanced pilot according to claim 39, further comprising a swirler mechanism disposed solely within the pilot and a fuel entry port disposed downstream of the swirler mechanism.

44. The plasma enhanced pilot according to claim 39, further comprising a swirler mechanism disposed solely within the pilot, wherein the swirler mechanism is configured with a single mixed fuel/air entry port.

45. The plasma enhanced pilot according to claim 39, further comprising:
a high voltage electrode; and
a low voltage electrode, wherein the high voltage electrode and the low voltage electrode together have a discharge gap distance between the electrodes of about 1.5 mm to about 3 mm.

46. The plasma enhanced pilot according to claim 39, further comprising:
a high voltage electrode; and
a low voltage electrode, wherein the high voltage electrode and the low voltage electrode together are configured to permit creation of electrical discharges using voltage levels less than about 100 kV at high pressures between about 5 atm and about 20 atm and temperatures between about 500° F. to about 900° F.

47. The plasma enhanced pilot according to claim 39, wherein the pilot further comprises an annular discharge passage configured to fit naturally within a swirl-stabilized fuel/air nozzle to support creation of a uniform electric discharge field.

48. The plasma enhanced pilot according to claim 39, further comprising a swirler mechanism disposed solely within the pilot, wherein the swirler mechanism is configured to provide a premixed, pre-swirled fuel/air mixture having an inherent aerodynamic stabilization that is sufficient without generation of pilot plasma to improve lean turn-down capabilities of the gas turbine combustor to a desired level.

49. The plasma enhanced pilot according to claim 39, further comprising a swirler mechanism disposed solely within the pilot, wherein the swirler mechanism is configured to provide a premixed, pre-swirled fuel/air mixture to enhance mixing of pilot flame gases with a main swirling premixed fuel/air flow generated by the gas turbine fuel nozzle.

50. The plasma enhanced pilot according to claim 49, wherein the swirler mechanism is configured to rotate in the same direction as a main swirler providing the main swirled premixed fuel/air flow.

51. The plasma enhanced pilot according to claim 49, wherein the swirler mechanism is configured to rotate in the opposite direction as a main swirler providing the main swirled premixed fuel/air flow.

52. The plasma enhanced pilot according to claim 39, further comprising a swirler mechanism disposed solely within the pilot, wherein the swirler mechanism is configured to provide a swirling motion of fuel/air inside the pilot electrical discharge volume that contributes to a desired distribution of discharge streamers.

53. The plasma enhanced pilot according to claim 39, further comprising a swirler mechanism disposed solely within the pilot, wherein the swirler mechanism is configured to provide a swirling motion of fuel/air inside the pilot electrical discharge volume that contributes to a desired distribution of diffuse glow volume.

54. The plasma enhanced pilot according to claim 39, wherein the pilot further comprises a high voltage electrode electrically insulated from the gas turbine combustor via high voltage insulating feedthrough elements.

55. The plasma enhanced pilot according to claim 39, further comprising a high voltage electrode and a low voltage electrode, the pilot configured to generate a plasma discharge therefrom such that the high voltage electrode and the low voltage electrode together initiate an electrical discharge in the premixed, pre-swirled fuel/air mixture in response to pulsed high voltage power or AC high voltage power, wherein the plasma discharge is located substantially at the entrance into the gas turbine combustor flame region.

56. The plasma enhanced pilot according to claim 55, wherein the pulsed or AC high voltage power is applied at about 10 kHz to about 50 kHz.

57. The plasma enhanced pilot according to claim 55, wherein the pulsed or AC high voltage power is modulated between about 10 Hz and about 2.5 kHz such that undesired gas turbine combustion tones are substantially eliminated.

58. The plasma enhanced pilot according to claim 39, wherein the pilot is configured to control the flow of a premixed fuel/air mixture in a pilot discharge region such that the premixed fuel/air mixture flows at a velocity high enough to prevent an ignited pilot flame from traveling upstream into the pilot cartridge, assist in the distribution of discharge streamers, substantially prevent formation of hot arcs, and assist in cooling of electrode surfaces.

59. The plasma enhanced pilot according to claim 58, wherein the premixed fuel/air mixture flow velocity is between about 150 feet/second and about 250 feet/second.

60. The plasma enhanced pilot according to claim 39, further comprising a swirler mechanism disposed solely within the pilot, wherein the swirler mechanism is configured to provide a premixed, pre-swirled fuel/air mixture selected from a fuel-lean mixture, a fuel-rich mixture, and a stoichiometric mixture.

61. The plasma enhanced pilot according to claim 39, further comprising a swirler mechanism disposed solely within the pilot, wherein the swirler mechanism is configured to provide a premixed, pre-swirled fuel/air mixture such that the ratio of the flow rate of premixed, pre-swirled, plasma-enhanced pilot fuel/air mixture and the flow rate of additional non-premixed purge air in the centerbody of the fuel nozzle can be adjusted to optimize performance of a plasma enhanced pilot flame in igniting and stabilizing combustion of a main premixed fuel/air mixture in the combustor.
